(19) United States
(12) Patent Application Publication
(10) Pub. No.: US 2020/0191696 A1
(43) Pub. Date: Jun. 18, 2020

(54) AIR PASSAGE STRUCTURE OF LASER-TYPE AIR QUALITY DETECTION MODULE

(71) Applicant: MAXMAC SHANGHAI AUTOMOTIVE ELECTRONIC CO., LTD., Shanghai (CN)

(72) Inventors: Yangxin Lin, Xiamen (CN); Changping Lin, Xiamen (CN); Minsong Lin, Xiamen (CN)

(21) Appl. No.: 16/711,436

(22) Filed: Dec. 12, 2019

(30) Foreign Application Priority Data
Dec. 13, 2018 (CN) 201811524772.X

(51) Int. Cl. G01N 15/06

(52) U.S. Cl. CPC G01N 15/06; G01N 2015/0693

(57) ABSTRACT

An air passage structure of a laser-type air quality detection module includes an air inlet passage, a primary air passage and a secondary air passage for accommodating a photoelectric element of the laser-type air quality detection module. A side wall of the secondary air passage is provided with a light entrance and a light exit facing the light entrance. The primary air inlet of the primary air passage and the secondary air inlet of the secondary air passage communicate with the air outlet of the air inlet passage. The secondary air inlet has a cross-sectional area less than that of the primary air inlet. Through the air passage structure, the service life of the laser-type air quality detection module can be prolonged.

### BACKGROUND OF THE INVENTION

### 1. Field of the Invention

The present invention relates to an air quality detection device, and more particularly to an air passage structure of a laser-type air quality detection module.

### 2. Description of the Prior Art

As shown in FIG. 1, in the prior art, a laser PM2.5 air quality detection module generally includes an air passage 1′, a light-absorbing recess 2′, a laser module 3′, and a photoelectric element 4′. The photoelectric element 4′ generally uses a photodiode. In general, the air passage 1′ is a single air passage structure. The air passage 1′ has an air inlet 11′ and an air outlet 12′. The side wall of the air passage 1′ is provided with a light entrance 13′ and a light exit 14′ facing the light entrance 13′. The light entrance 13′ is configured for laser light incidence. The light exit 14′ is configured for laser light reflection. The light-absorbing recess 2′ is configured to absorb laser light. The light-absorbing recess 2′ is disposed outside the air passage 1′ and communicates with the light exit 14′. The photoelectric element 4′ is disposed in the air passage 1′. The laser module 3′ is disposed outside the air passage 1′ and is configured to emit laser light from the light entrance 13′ to the air passage 1′. When the conventional PM2.5 air quality detection module is in use, the detected airflow passes from the air inlet 11′ to the air passage 1′. The laser light emitted from the laser module 3′ enters the air passage 1′ through the light entrance 13′. Part of the laser light entering the air passage 1′ comes out from the light exit 14′ to the light-absorbing recess 2′ to be absorbed by the light-absorbing recess 2′, and the other part of the laser light collides with the particles contained in the detected airflow entering the air passage 1′ and is scattered. The scattered laser light is absorbed by the photoelectric element 4′, so the photoelectric element 4′ generates a current. If there are more particles contained in the detected airflow entering the air passage 1′, the more laser light is absorbed by the photoelectric element 4′. Therefore, the magnitude of the current generated by the photoelectric element 4′ can reflect the air quality of the detected airflow. This laser-type PM2.5 air quality detection module has a problem that the air passage 1′ is easy to accumulate dust. The dust will cover the photoelectric element 4′, which greatly reduces the detection accuracy and the service life of the laser-type PM2.5 air quality detection module. It is not easy to clear the dust accumulated in the air passage 1′. By reducing the flow rate of the detected airflow, the dust entering the air passage 1′ is reduced to delay the time that the photoelectric element 4′ is completely covered by the dust, thereby prolonging the service life of the laser PM2.5 air quality detection module. However, if the flow rate of the detected airflow in the air passage 1′ is too low, the detection sensitivity and anti-interference performance of the laser PM2.5 air quality detection module will be reduced.

### SUMMARY OF THE INVENTION

The primary object of the present invention is to provide an air passage structure of a laser-type air quality detection module. The service life of the laser-type air quality detection module can be prolonged without affecting the detection sensitivity and anti-interference performance of the laser-type air quality detection module.

In order to achieve the above object, the present invention adopts the following technical solutions:

An air passage structure of a laser-type air quality detection module comprises an air inlet passage having an air inlet and an air outlet, a primary air passage having a primary air inlet and a primary air outlet, and a secondary air passage having a secondary air inlet and a secondary air outlet. The secondary air passage is configured to accommodate a photoelectric element of the laser-type air quality detection module. A side wall of the secondary air passage is provided with a light entrance and a light exit facing the light entrance. The primary air inlet of the primary air passage and the secondary air inlet of the secondary air passage communicate with the air outlet of the air inlet passage. The secondary air inlet has a cross-sectional area less than that of the primary air inlet.

Preferably, the cross-sectional area of the secondary air inlet is 10% to 30% of the cross-sectional area of the primary air inlet.

Preferably, the secondary air outlet of the secondary air passage is formed on a side wall of the primary air passage, and the secondary air outlet has a cross-sectional area less than that of the primary air inlet.

Preferably, the cross-sectional area of the secondary air outlet is 10% to 30% of the cross-sectional area of the primary air inlet.

Preferably, an outer end of the light entrance communicates an accommodating chamber that is configured to retain a laser module, and an outer end of the light exit communicates with a recess that is configured to absorb laser light.

Preferably, an air outlet direction of the air outlet is the same as an air inlet direction of the primary air inlet.

Preferably, a first included angle between an air inlet direction of the primary air inlet and an air inlet direction of the secondary air inlet is a right angle or an obtuse angle.

Preferably, an air outlet direction of the air outlet is perpendicular to an air inlet direction of the primary air inlet.

Preferably, an air outlet direction of the air outlet is the same as an air inlet direction of the secondary air inlet.

Preferably, a first included angle between an air inlet direction of the primary air inlet and an air inlet direction of the secondary air inlet is an obtuse angle, and a second included angle between an air outlet direction of the air outlet and the air inlet direction of the secondary air inlet is an acute angle.

When the laser-type air quality detection module adopts the air passage structure of the present invention, part of the detected airflow from the air inlet passage will flow to the primary air passage via the primary air inlet, and the other part of the detected airflow will flow to the secondary air passage via the secondary air inlet. Because the cross-sectional area of the secondary air inlet is less than the cross-sectional area of the primary air inlet, the mass flow rate of the detected airflow at the secondary air inlet is less than the mass flow rate of the detected airflow at the primary air inlet, so that there is less dust entering the secondary air passage, thereby prolonging the time that the photoelectric element in the secondary air passage is completely covered by the dust, so as to prolong the service life of the laser-type air quality detection module. Without reducing the flow rate of the detected airflow, the detection sensitivity and anti-interference performance of the laser-type air quality detection module will not be affected.

### BRIEF DESCRIPTION OF THE DRAWINGS

FIG. 1 is a schematic structural view of a conventional laser PM2.5 air quality detection module;

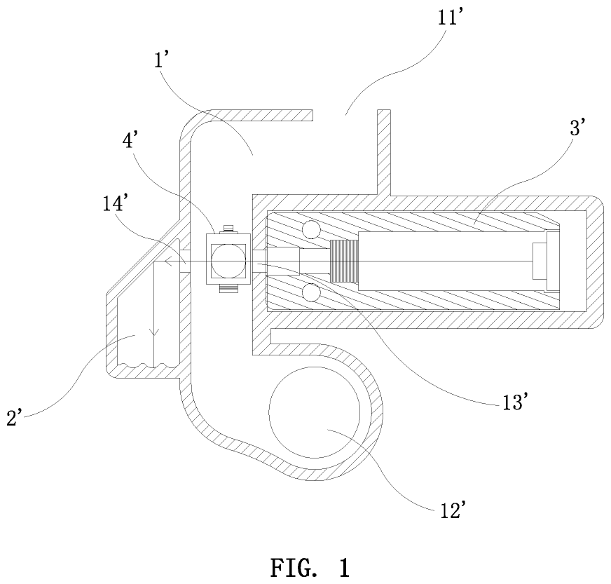

FIG. 2 is a schematic structural view of a first embodiment of the present invention;

FIG. 3 is a schematic structural view of a second embodiment of the present invention;

FIG. 4 is a schematic structural view of a third embodiment of the present invention;

FIG. 5 is a schematic structural view of a fourth embodiment of the present invention; and

FIG. 6 is a schematic structural view of a fifth embodiment of the present invention.

### DETAILED DESCRIPTION OF THE PREFERRED EMBODIMENTS

Embodiments of the present invention will now be described, by way of example only, with reference to the accompanying drawings.

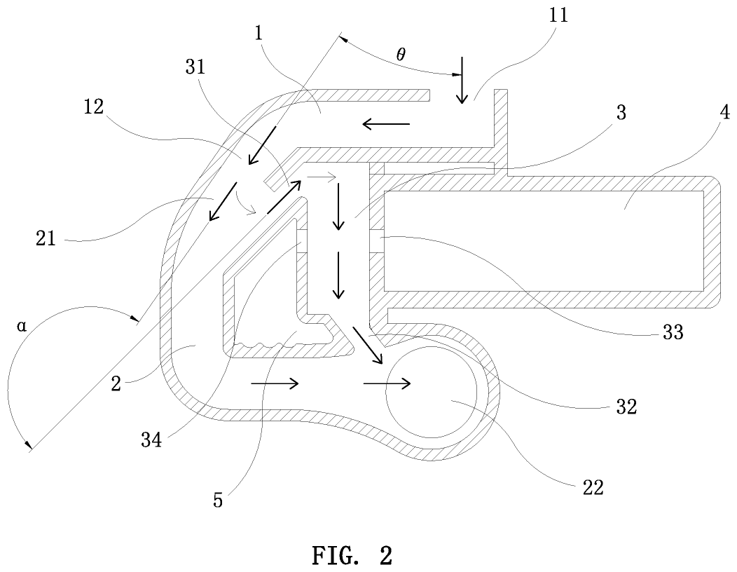

As shown in FIG. 2 to FIG. 6, the present invention discloses an air passage structure of a laser-type air quality detection module, comprising an air inlet passage 1 having an air inlet 11 and an air outlet 12, a primary air passage 2 having a primary air inlet 21 and a primary air outlet 22, and a secondary air passage 3 having a secondary air inlet 31 and a secondary air outlet 32. The secondary air passage 3 is configured to accommodate a photoelectric element of the laser-type air quality detection module. The side wall of the secondary air passage 3 is provided with a light entrance 33 and a light exit 34 facing the light entrance 33. The light entrance 33 is configured for laser light incidence. The outer end of the light entrance 33 communicates with an accommodating chamber 4 that is configured to retain a laser module. The light exit 34 is configured for laser light reflection. The outer end of the light exit 34 communicates with a recess 5 that is configured to absorb laser light.

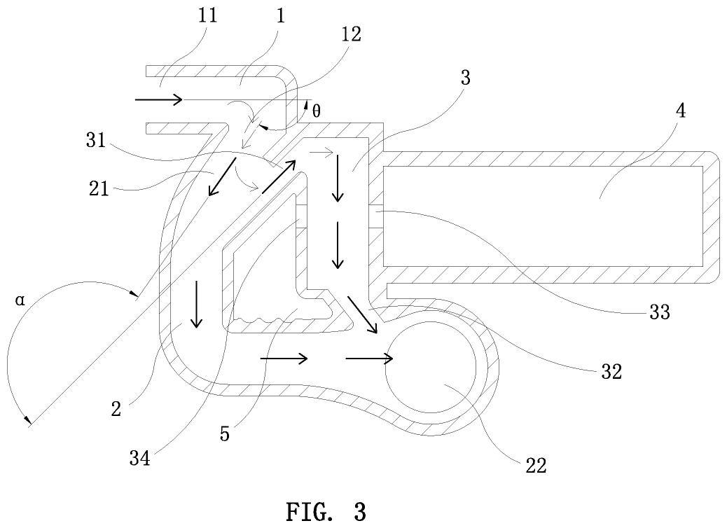

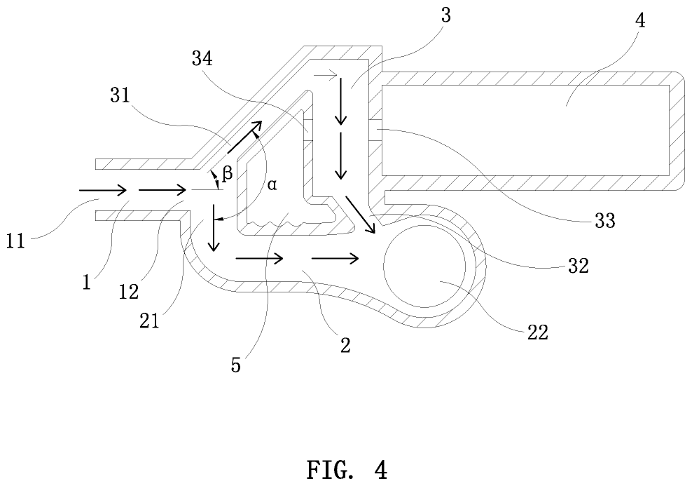

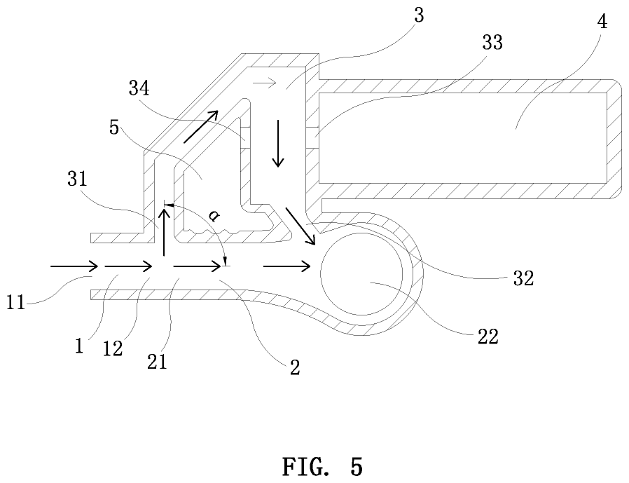

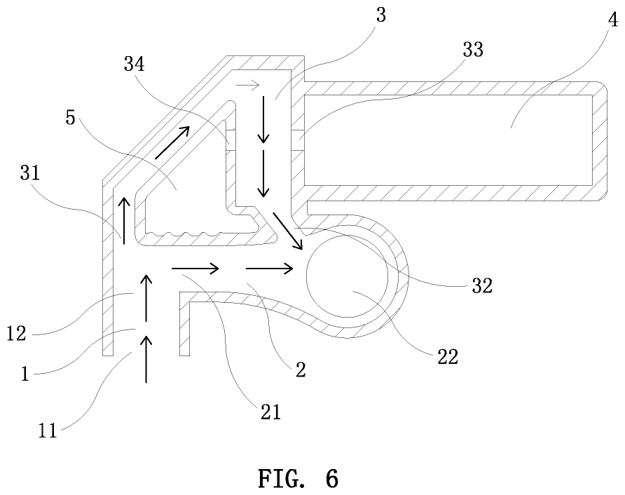

As shown in FIG. 2 to FIG. 6, the primary air inlet 21 of the primary air passage 2 and the secondary air inlet 31 of the secondary air passage 3 communicate with the air outlet 12 of the air inlet passage 1. The cross-sectional area of the secondary air inlet 31 is less than the cross-sectional area of the primary air inlet 21. The cross-sectional area of the secondary air inlet 31 is preferably 10% to 30% of the cross-sectional area of the primary air inlet 21. The secondary air outlet 32 of the secondary air passage 3 is formed on the side wall of the primary air passage 2. The cross-sectional area of the secondary air outlet 32 is less than the cross-sectional area of the primary air inlet 21. The cross-sectional area of the secondary air outlet 32 is preferably 10% to 30% of the cross-sectional area of the primary air inlet 21. As shown in FIG. 2, in a first embodiment of the present invention, a third included angle θ between the air inlet direction of the air inlet 11 of the air inlet passage 1 and the air outlet direction of the air outlet 12 is an acute angle. The air outlet direction of the air outlet 12 is the same as the air inlet direction of the primary air inlet 21. A first included angle α between the air inlet direction of the primary air inlet 21 and the air inlet direction of the secondary air inlet 31 is an obtuse angle. As shown in FIG. 3, in a second embodiment of the present invention, a third included angle θ between the air inlet direction of the air inlet 11 of the air inlet passage 1 and the air outlet direction of the air outlet 12 is an obtuse angle. The air outlet direction of the air outlet 12 is the same as the air inlet direction of the primary air inlet 21. A first included angle α between the air inlet direction of the primary air inlet 21 and the air inlet direction of the secondary air inlet 31 is an obtuse angle. As shown in FIG. 4, in a third embodiment of the present invention, the air inlet direction of the air inlet 11 of the air inlet passage 1 is the same as the air outlet direction of the air outlet 12. The air outlet direction of the air outlet 12 is perpendicular to the air inlet direction of the primary air inlet 21. A first included angle α between the air inlet direction of the primary air inlet 21 and the air inlet direction of the secondary air inlet 31 is an obtuse angle. A second included angle β between the air outlet direction of the air outlet 12 and the air inlet direction of the secondary air inlet 31 is an acute angle. As shown in FIG. 5, in a fourth embodiment of the present invention, the air inlet direction of the air inlet 11 of the air inlet passage 1 is the same as the air outlet direction of the air outlet 12. The air outlet direction of the air outlet 12 is the same as the air inlet direction of the primary air inlet 21. A first included angle α between the air inlet direction of the primary air inlet 21 and the air inlet direction of the secondary air inlet 31 is a right angle. As shown in FIG. 6, in a fifth embodiment of the present invention, the air inlet direction of the air inlet 11 of the air inlet passage 1 is the same as the air outlet direction of the air outlet 12. The air outlet direction of the air outlet 12 is perpendicular to the air inlet direction of the primary air inlet 21. The air outlet direction of the air outlet 12 is the same as the air inlet direction of the secondary air inlet 31.

When the laser-type air quality detection module adopts the air passage structure of the present invention, because the primary air inlet 21 of the primary air passage 2 and the secondary air inlet 31 of the secondary air passage 3 communicate with the air outlet 12 of the air inlet passage 1, part of the detected airflow from the air inlet passage 1 flows to the primary air passage 2 via the primary air inlet 21, and the other part of the detected airflow flows to the secondary air passage 3 via the secondary air inlet 31. Because the cross-sectional area of the secondary air inlet 31 is less than the cross-sectional area of the primary air inlet 21, the mass flow rate of the detected airflow at the secondary air inlet 31 is less than the mass flow rate of the detected airflow at the primary air inlet 21. Thus, the mass flow rate of the detected airflow entering the secondary air passage 3 is small, so that there is less dust entering the secondary air passage 3, thereby prolonging the time that the photoelectric element in the secondary air passage 3 is completely covered by the dust, so as to ensure the service life of the laser-type air quality detection module. Therefore, the present invention can reduce the mass flow rate of the detected airflow entering the secondary air passage 3 without reducing the flow rate of the detected airflow, so as to ensure the service life of the laser-type air quality detection module. Without reducing the flow rate of the detected airflow, the detection sensitivity and anti-interference performance of the laser-type air quality detection module will not be affected. In addition, the primary air inlet 21 of the primary air passage 2 and the secondary air inlet 31 of the secondary air passage 3 communicate with the air outlet 12 of the air inlet passage 1, and the cross-sectional area of the secondary air inlet 31 is less than the cross-sectional area of the primary air inlet 21, so large particles with a particle size greater than 10 microns contained in the detected airflow from the air inlet passage 1 will enter the main air passage 2 under the inertia effect and then be discharged. In this way, large particles with a particle size greater than 10 microns in the detected airflow entering the secondary air passage 3 are reduced, thereby reducing the interference of large particles with a particle size greater than 10 microns on the detection of the laser-type air quality detection module.

Although particular embodiments of the present invention have been described in detail for purposes of illustration, various modifications and enhancements may be made without departing from the spirit and scope of the present invention. Accordingly, the present invention is not to be limited except as by the appended claims

What is claimed is:

1. An air passage structure of a laser-type air quality detection module, comprising an air inlet passage having an air inlet and an air outlet, a primary air passage having a primary air inlet and a primary air outlet, and a secondary air passage having a secondary air inlet and a secondary air outlet; the secondary air passage being configured to accommodate a photoelectric element of the laser-type air quality detection module, a side wall of the secondary air passage being provided with a light entrance and a light exit facing the light entrance; the primary air inlet of the primary air passage and the secondary air inlet of the secondary air passage communicating with the air outlet of the air inlet passage, the secondary air inlet having a cross-sectional area less than that of the primary air inlet.

2. The air passage structure of the laser-type air quality detection module as claimed in claim 1, wherein the cross-sectional area of the secondary air inlet is 10% to 30% of the cross-sectional area of the primary air inlet.

3. The air passage structure of the laser-type air quality detection module as claimed in claim 1, wherein the secondary air outlet of the secondary air passage is formed on a side wall of the primary air passage, and the secondary air outlet has a cross-sectional area less than that of the primary air inlet.

4. The air passage structure of the laser-type air quality detection module as claimed in claim 3, wherein the cross-sectional area of the secondary air outlet is 10% to 30% of the cross-sectional area of the primary air inlet.

5. The air passage structure of the laser-type air quality detection module as claimed in claim 1, wherein an outer end of the light entrance communicates with an accommodating chamber that is configured to retain a laser module, and an outer end of the light exit communicates with a recess that is configured to absorb laser light.

6. The air passage structure of the laser-type air quality detection module as claimed in claim 1, wherein an air outlet direction of the air outlet is the same as an air inlet direction of the primary air inlet.

7. The air passage structure of the laser-type air quality detection module as claimed in claim 1, wherein a first included angle between an air inlet direction of the primary air inlet and an air inlet direction of the secondary air inlet is a right angle or an obtuse angle.

8. The air passage structure of the laser-type air quality detection module as claimed in claim 1, wherein an air outlet direction of the air outlet is perpendicular to an air inlet direction of the primary air inlet.

9. The air passage structure of the laser-type air quality detection module as claimed in claim 1, wherein an air outlet direction of the air outlet is the same as an air inlet direction of the secondary air inlet.

10. The air passage structure of the laser-type air quality detection module as claimed in claim 1, wherein a first included angle between an air inlet direction of the primary air inlet and an air inlet direction of the secondary air inlet is an obtuse angle, and a second included angle between an air outlet direction of the air outlet and the air inlet direction of the secondary air inlet is an acute angle.
